(19) United States
(12) Patent Application Publication
(10) Pub. No.: US 2013/0136223 A1
(43) Pub. Date: May 30, 2013

(54) METHOD FOR TREATING NEUTRONS GENERATED FROM SPENT NUCLEAR FUEL

(71) Applicants: Jei-Won YEON, Daejeon (KR); Jong-Yun KIM, Daejeon (KR); Euo-Chang JUNG, Daejeon (KR); KyuSeok SONG, Daejeon (KR)

(72) Inventors: Jei-Won YEON, Daejeon (KR); Jong-Yun KIM, Daejeon (KR); Euo-Chang JUNG, Daejeon (KR); KyuSeok SONG, Daejeon (KR)

(73) Assignees: KOREA HYDRO AND NUCLEAR POWER CO., LTD.; KOREA ATOMIC ENERGY RESEARCH INSTITUTE

(21) Appl. No.: 13/560,710

(22) Filed: Jul. 27, 2012

(30) Foreign Application Priority Data
Nov. 29, 2011 (KR) 10-2011-0126306

(51) Int. Cl. G21C 7/06; G21C 7/24

(52) U.S. Cl. 376/219

(57) ABSTRACT

A method for treating neutrons generated from spent nuclear fuel is provided, which includes a step of injecting neutron absorption material into the spent nuclear fuel storage water in which cooling function is lost. Accordingly, as the neutron absorption material in the form of particles is injected into a spent nuclear storage pool missing cooling function and deposited on the surface of the spent nuclear fuel, the possibility reaching nuclear criticality is reduced since the neutrons generated from spent nuclear fuel are absorbed. Also, immediate neutron absorbing power is provided upon refilling the pool water into the spent nuclear fuel storage pool in which pool water is depleted.

### CROSS-REFERENCE TO RELATED APPLICATIONS

This application claims priority from Korean Patent Application No. 10-2011-126306, filed on Nov. 29, 2011, in the Korean Intellectual Property Office, the disclosure of which is incorporated herein by reference in its entirety.

### BACKGROUND OF THE INVENTION

1. Field of the Invention

The invention relates to a method for treating neutrons generated from spent nuclear fuel.

2. Description of the Related Art

In general, decay heat is continuously emitted from the spent nuclear fuel burned up in nuclear reactor for a long period of time due to high-heat-emitting radionuclides. In order to remove the decay heat, the spent nuclear fuel is placed in a storage pool having cooling function for a while after the fuel is discharged from the nuclear reactor. Since many fissile materials remain in the spent nuclear fuel, the amount for storage is managed to be within a predetermined range not to reach critical mass. Also, in order to prevent reaching criticality for safety purpose, boric acid is added to absorb neutrons into the storage pool water, and a fuel housing rack including neutron absorption material therein is provided between fuel assemblies to absorb the neutrons emitted from the fuel.

As we learned from the nuclear accident in Japan in 2011, if cooling function does not work normally in a spent nuclear fuel storage pool and spent nuclear fuel intermediate storage pool, storage water is evaporated due to decay heat of high-heat-emitting radionuclides in the fuel, and thus hydrogen explosion is happened by hydrogen gas generated by high temperature oxidation of metal cladding material. Also, as the temperature is continuously increased, the spent nuclear fuel is melted and gathered at the bottom of the storage pool. At this time, although the boric acid is added to the pool water as a neutron absorption material, the boric acid, which is water soluble, forms precipitates inside of the storage pool when storage water is evaporated, thereby hindering proper neutrons absorption function. That is, melted nuclear fuel at the bottom of the storage pool exceeds the critical mass of nuclear reaction and the possibility reaching nuclear criticality is increased.

Furthermore, it is required that only high concentrated boric acid solution can be used as supplementary coolant to supplement the lost coolant of spent nuclear fuel, since it takes a long time (i.e., more than several hours) to re-dissolve precipitates of boric acid completely.

Regarding the technology to improve safety of re-criticality of a spent nuclear fuel storage pool, U.S. Pat. No. 5,085,825 A (Feb. 4, 1992) teaches injection of coolant including neutron absorption material inside of a nuclear reactor by introducing the concept of multiple safety injection, and the safety of the nuclear reactor has been increased. In addition, Japanese Patent No. 2005-181238 (Jul. 7, 2005) describes the technique to prepare multiple spray nozzles which can inject boric acid into spent nuclear fuel storage facility of nuclear plant and to spray borated water stored in borated water storage tank by using pump before reaching nuclear critical mass. So far, most of developed techniques such as the above-mentioned patents have only focused on how to inject boric acid into storage pool efficiently. That is, the problem involved with the use of boric acid still remains unsolved.

Meanwhile, in order to improve safety of the nuclear reactor or spent nuclear fuel storage pool, the technique using soluble neutron absorption material such as boric acid and particle-shaped neutron absorption material simultaneously has been developed and, instead of spraying the absorption materials into coolant, the neutron absorption material is mixed with the materials of a spent nuclear fuel storage rack. European Patent No. 0016252 (A1) (Oct. 1, 1980) teaches a method for improving the neutron absorbing power by spraying neutron absorption material into the material of the spent nuclear fuel storage rack. Also, Korean Patent No. 10-1020784 (granted on Mar. 2, 2011) provides the coolant for use in emergency core cooling system of super critical water-cooled reactor and proposes injecting B₄C emergently to be used as neutron absorption particles of coolant.

As explained above, boric acid has been used as a neutron absorber in the spent nuclear fuel storage water, and the particle-shaped neutron absorption material has been mixed and used for the rack installed between spent nuclear fuel assemblies, instead of being added to the storage water. Accordingly, based on the prior art, if boric acid precipitates are caused by the depletion of storage water, proper neutron absorption function may not be provided.

In this regard, while searching for a way to ensure efficient neutrons absorption even in the event in which cooling function of spent nuclear fuel storage pool is shut down, the inventors of the present invention focused on the phenomenon in which fine particles are deposited on the boiling surface and discovered that the neutron absorbing ability for the spent nuclear fuel is maintained, by adding fine particle-shaped neutron absorption material into the storage water, and subsequently causing the neutron absorption material to be deposited on the surface of the spent nuclear fuel. Accordingly, a method for treating neutron to maintain the neutron absorbing ability for the spent nuclear fuel was developed, and the present invention was completed.

### SUMMARY OF THE INVENTION

The present invention aims to provide a method for treating neutrons generated from spent nuclear fuel.

In order to achieve the object explained above, the present invention provides a method for treating neutrons generated from a spent nuclear fuel including a step of injecting neutron absorption material into spent nuclear storage water in which the cooling function is lost.

According to a method for treating neutrons generated from a spent nuclear fuel of the present invention, neutron absorption material is easily deposited on the boiling surface of spent nuclear fuel by injecting particle-shaped neutron absorption material into the spent nuclear storage water in which cooling function is lost. Accordingly, the neutrons generated from the spent nuclear fuel are absorbed and the possibility reaching criticality is reduced. Further, the neutrons are immediately absorbed when storage water is refilled in the spent nuclear fuel storage pool in which storage water is depleted.

### BRIEF DESCRIPTION OF THE DRAWINGS

The above and/or other aspects of what is described herein will be more apparent by describing certain exemplary embodiments with reference to the accompanying drawings, in which:

FIG. 1 provides schematic views illustrating a process in which deposit of dispersed particles is accelerated by water boiling;

FIG. 2 is a schematic view illustrating an apparatus for treating neutrons performing a method for treating neutron according to an embodiment;

FIG. 3 presents images of laboratory equipments employed in order to perform deposit test of neutron absorption material;

FIGS. 4 and 5 present images of heater on which neutron absorption material is deposited; and

FIG. 6 presents a graph which shows pH change of the solution depending on the amount of injected neutron absorption material.

### DETAILED DESCRIPTION OF EXEMPLARY EMBODIMENTS

Embodiments of the present invention will be explained in greater detail below.

The present invention provides a method for treating neutrons generated from a spent nuclear fuel including a step for injecting neutron absorption material into a spent nuclear fuel storage water in which cooling function is lost.

Spent nuclear fuel continuously generates heat due to the high-heat-emitting radionuclides of the fuel, which are the product of nuclear fission. Therefore, spent nuclear fuel is placed in the storage pool water. For the currently-available spent nuclear storage pool, soluble boric acid is most widely used as a neutron absorption material, since the soluble boric acid provides easy purification and management of the storage water. However, in an emergency situation such as lack of cooling function and storage water in the storage pool, the soluble boric acid is concentrated and precipitated in the bottom of the pool. Accordingly, neutron absorbing power disappears.

According to a method for treating neutrons of the present invention, the neutrons generated from the spent nuclear fuel are treated not to leak out because neutron absorption material is injected into the spent nuclear storage water in which cooling function is lost. The injected neutron absorption material is not dissolved in the storage water, but deposited on the surface of the spent nuclear fuel. Therefore, the neutrons are absorbed even when all the storage water is depleted. Also, the neutron absorption material injected into storage water is preferentially deposited on boiling surface. Since the place where the boiling occurs is on the surface of spent nuclear fuel, the neutrons can be more effectively absorbed through the deposit reaction promoted by the water boiling.

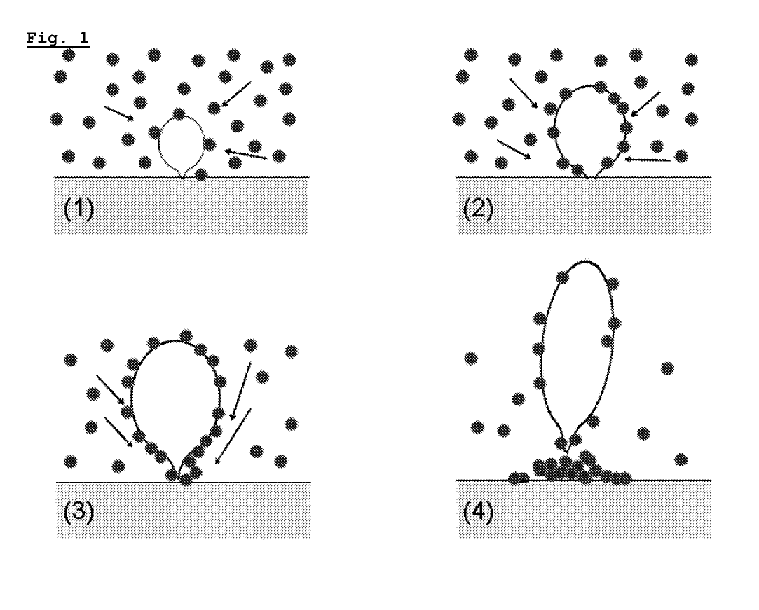

FIG. 1 presents schematic views illustrating a process in which the deposit of dispersed particles is accelerated by water boiling. Referring to FIG. 1, dispersed particles are pushed to bubble the interface of water and vapor by water boiling, and when vapor bubble escapes from the boiling surface, the particles are left on the boiling surface, and thus, deposited thereon. As the particles keep depositing, the deposit layer dispersed particles becomes thicker, and a boiling chimney is formed to further accelerate the deposit of the particles.

Water boiling leads into the deposit of dispersed particles; however, to this purpose, it is necessary that the particles injected into the storage pool are dispersed into coolant with stability and moved to the boiling surface of the spent nuclear fuel. Accordingly, in order to lead into proper particle-deposit, dispersion property of the particle matters. In general, the dispersion property of micro-particle varies depending on the particle size. According to “Introduction to Colloid and Surface Chemistry” (Duncan J. Shaw, Bitterworth-Heinemann, 4^{th} ed., page 1, 1992), if the particles having a diameter of 1 nm to 1 μm are dispersed in the medium, it is called colloid and stable dispersion is maintained without requiring any external energy. If the medium is water, even though the particle size is below 1 μm diameter, the dispersion is well performed at room temperature, and if water flows by heat convection or physical power, even larger particles may be dispersed with stability. According to the present invention (See Example 1.), it is recognized that the particles having average diameter of 5 μm and under are well deposited on the boiling surface.

Meanwhile, neutron absorbing power is proportionate to the mass of material and the mass of the particles are proportionate to the cube of diameter thereof. Accordingly, if micro-particles having below 10 nm of diameter are used, the neutron absorbing power becomes weaker due to smaller mass of the particles.

Therefore, for the size of the neutron absorption material, average diameter is preferably 5 μm and under, and more preferably, in a range of 10 nm to 1 μm. The micro-particle neutron absorption material within the range is deposited on the boiling surface under the condition in which storage water is boiled, and is able to absorb the neutrons emitted from the spent nuclear fuel effectively.

The neutron absorption material injected into spent fuel storage water preferably includes the element which has a large neutron absorption cross-section value. Therefore, the neutron absorption material may include one or more kinds selected from the group comprising boron (B), gadolinium (Gd), silver (Ag) and cadmium (Cd), more preferably, the neutron absorption material may be boron or gadolinium carbide, boron or gadolinium oxide, boron or gadolinium nitride, or boride metal, or most preferably, B₄C, B₂O₃, BN, Gd₂O₃, GdC₂.GdN or TiB₂.

Also, even among isotopes, the neutron absorbing power varies depending on the mass of the element. For example, among boron having 10 mass number (B-10) and boron having 11 mass number (B-11), which are isotopes, B-10 has high absorbing power, but B-11 does not absorb neutrons at all. Natural boron consists of 19.9% of B-10 and 80.1% of B-11. By artificially enriched boron with high B-10 content having high neutron absorbing power, higher neutron absorbing power can be obtained from the same amount of material. That is, if the neutron absorption material includes boron such as B₄C, B₂O₃, BN or TiB₂, the neutron absorption material preferably has at least 19.9% of B-10 isotope, and if the neutron absorption material includes gadolinium such as Gd₂O₃, GdC₂.GdN, the materials preferably have at least 15.65% of Gd-157 isotope. B-10 and Gd-157 are the isotopes each having absorbing power in corresponding elements; therefore, neutron absorption material with increased performance can be fabricated by increasing the content of such isotopes.

The neutron absorption material hydrolyzes water molecule and change pH of the dispersed solution when the neutron absorption material is dispersed into the storage with stability. For example, when B₄C micro-particles are dispersed into storage water, hydroxyl group (—OH) is absorbed on the surface of the particles and become stable, thereby causing pH of the storage water to decrease and turn to strong acidic solution. If pH of the storage water is decreased, dispersion capacity of neutron absorption material decreases, and volatility of radiation iodine increases. Therefore, in order to prevent increasing volatility of radiation iodine, pH control agents may be injected along with the neutron absorption micro-particles.

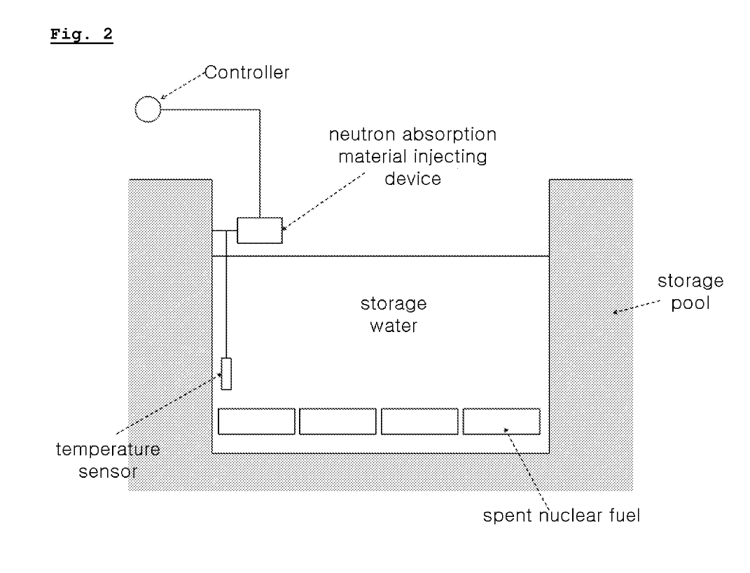

According to an embodiment of the present invention, the method described above may be implemented by using an apparatus for treating neutrons, including: a temperature sensor which measures the temperature of a spent nuclear fuel; and a neutron absorption material injecting device which injects neutron absorption material into spent nuclear storage water, when the temperature of the spent nuclear fuel storage water is changed. FIG. 2 schematically illustrates an apparatus for treating neutrons according to a preferred embodiment.

Referring to FIG. 2, an apparatus for treating neutrons includes a temperature sensor which measures temperature of spent nuclear storage water to check cooling function of the spent nuclear fuel storage pool and a neutron absorption material injecting device which injects neutron absorption material when determining loss of cooling function of storage pool through the temperature sensor. Also, when the temperature change is detected by the temperature sensor, the neutron absorption material injecting device may automatically or semi-automatically operate to inject the neutron absorption material into the storage water.

The basic principal to operate an apparatus for treating neutrons will be explained below. If the cooling function of spent nuclear fuel storage pool is lost, the temperature thereof is increased. As soon as the temperature sensor detects the change of the temperature, a neutron absorption material injecting device is operated and the neutron absorption material injecting device may automatically inject neutron absorption material into storage pool or alternatively, semi-automatically inject neutron absorption material by a worker who recognizes temperature change of the storage water.

The temperature at which the neutron absorption material is injected may be set higher than 25° C., which is the normal temperature of the storage water, and the range of temperature may be divided into stages to judge system error, if necessary. For instance, the range of temperature may be set as caution above 30° C., warning above 40° C. and emergency above 60° C.; therefore, systemic reaction can be prepared for the abnormal condition of the storage water.

In response to the temperature change of the storage water, the neutron absorption material is injected into the storage water, and primarily deposited on the surface of the spent nuclear fuel metal cladding material where boiling is started with the heat of spent nuclear fuel, among the various structure surfaces including outer surface of the storage water and fuel storage rack contacting storage water. Since the position where boiling starts has the intensive heat emission, i.e., high mass of the spent nuclear fuel, the restart possibility of nuclear fission reaction is most likely. That is, since the apparatus for treating neutrons injects neutron absorption material into the storage water, the neutron absorption material is primarily deposited on the surface of nuclear fuel at the position where the spent nuclear fuel is densely placed, and thus the absorption of neutrons can be performed effectively.

Meanwhile, the apparatus for treating neutrons may additionally include a pH control device. If pH change of the storage water is extreme, the pH control device regulates pH of the storage water by injecting pH control agents. However, the injection of neutron absorption material may cause instable dispersion of neutron absorption material due to decrease of absolute value of zeta potential. Therefore, the apparatus for treating neutrons may preferably include a pH control device, but this should not be construed as limiting.

Examples of the present invention will now be described in further detail below. It would be obvious to those skilled in the art that these examples are intended to be more concretely illustrative and the scope of the present invention as set forth in the appended claims is not limited to or by the examples.

### Example 1

### Analyzing Deposit of Neutron Absorption Material

The following experiment was performed in order to prove that, when storage water of spent nuclear fuel storage pool loses cooling function, neutrons can be absorbed effectively by the neutron absorption material injected and deposited on the surface of spent nuclear fuel according to a method of the present invention.

In order to simulate spent nuclear fuel emitting heat, a small rod heater (4.7 W/cm²) having 100 W of heat output, boric acid solution (1,500 ppm B) and the solution in which B₄C particles were dispersed into boric acid solution with 5,000 ppm concentration based on boron, were prepared. Sodium hydroxide (NaOH) was added to the boric acid solution and the borated solution B₄C particles were dispersed, and the pH thereof was regulated to 7.5.

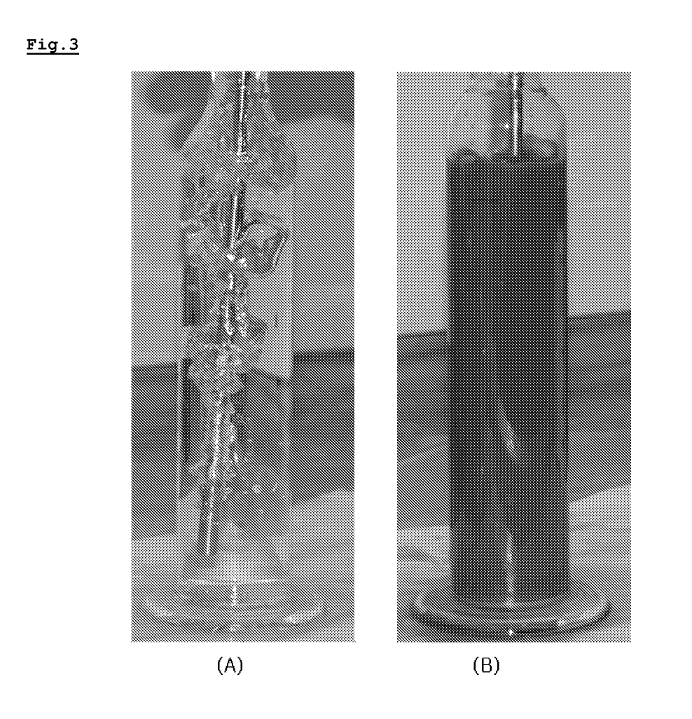

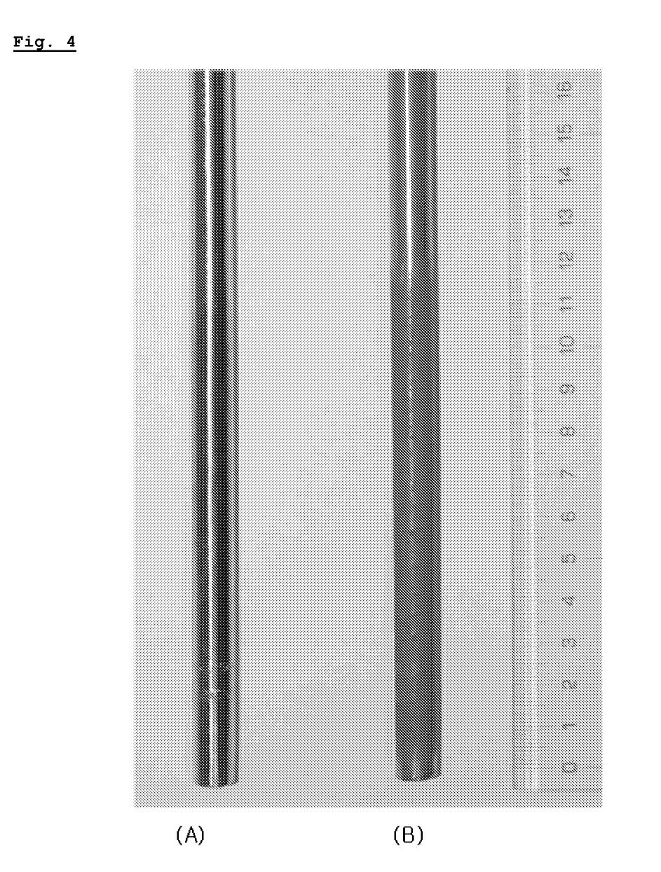

Referring to FIG. 3, the rod heater was installed in the borated solution (A), and the solution with dispersed B₄C particles(B) was caused to boil by adding heat for 20 min with an electric heater. The surface of the heater in which boiling was occurred was then observed. FIGS. 4 and 5 show the surface of the heater in which boiling is occurred.

Referring to FIG. 4, no deposit was observed on the surface of the heater (A) which was boiled in the borated solution; however, there were many B₄C particles deposited on the surface of the heater (B) with dispersed B₄C particles. The amount of deposited B₄C was about 230 g/cm² when the heat output was 4.7 W/cm².

In addition, referring to the FIG. 5, on closer observation, the surface of heater in which deposit was generated, had many B₄C particles deposited at the area boiling was generated by heat rays, but no deposit was occurred in non-boiling zone; therefore, it was confirmed that water boiling accelerated deposit of the neutron absorption material such as B₄C.

### Example 2

### Analyzing pH Change by Neutron Absorption Material

The following experiment was performed in order to observe the pH change of the storage water when the neutron absorption material was dispersed into the storage water with stability by the injection of neutron absorption material according to the treatment of the present invention.

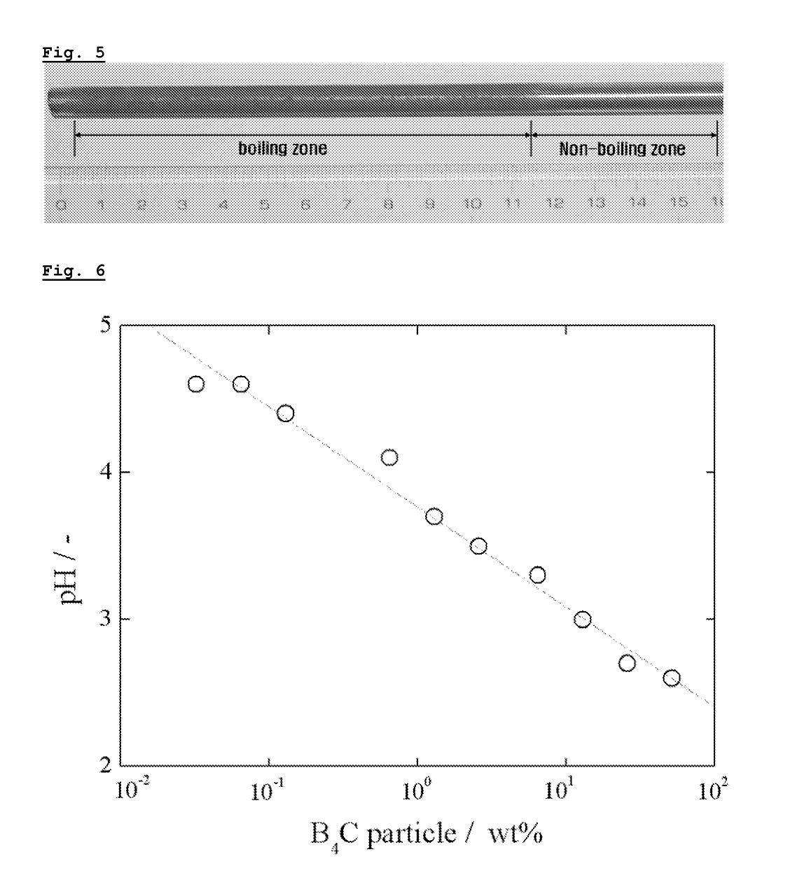

Among the solutions of Example 1, pH change of the solution with dispersed B₄C particles was measured, and the result is shown in FIG. 6.

Referring to FIG. 6, pH value was reduced as the amount of injected and dispersed B₄C increased. That is, when the neutron absorption material (B₄C), was dispersed, hydroxyl group (—OH) was absorbed on the surface of the B₄C and thus it was confirmed that pH of the storage water was decreased. Meanwhile, if dramatic pH change is occurred due to injection of neutron absorption material, the stable dispersion of the neutron absorption material may be disturbed by reducing zeta potential. Accordingly, in the present invention, it was confirmed that when neutron absorption material could be dispersed with higher stability, pH control agents were injected into the storage water to neutralize pH of the storage water.

The foregoing embodiments and advantages are merely exemplary and are not to be construed as limiting the present invention. The present teaching can be readily applied to other types of apparatuses. Also, the description of the exemplary embodiments of the present inventive concept is intended to be illustrative, and not to limit the scope of the claims, and many alternatives, modifications, and variations will be apparent to those skilled in the art.

What is claimed is:

1. A method for treating neutrons generated from spent nuclear fuel, comprising injecting neutron absorption material into the spent nuclear fuel storage water in which cooling function is lost.

2. The method according to claim 1, comprising injecting the neutron absorption material into the spent nuclear fuel storage water so that the neutron absorption material deposits on the surface of the spent nuclear fuel under a condition that the storage water boils.

3. The method according to claim 1, wherein the neutron absorption material comprises one or more kinds selected from the group consisting of boron (B), gadolinium (Gd), silver (Ag) and cadmium (Cd).

4. The method according to claim 1, wherein the neutron absorption material is boron carbide or gadolinium carbide.

5. The method according to claim 1, wherein the neutron absorption material is boron oxide or gadolinium oxide.

6. The method according to claim 1, wherein the neutron absorption material is boron nitride or gadolinium nitride.

7. The method according to claim 1, wherein the neutron absorption material is one or more kinds selected from the group consisting of B₄C, B₂O₃, BN, Gd₂O₃, GdC₂, GdN and TiB₂.

8. The method according to claim 3, wherein the boron (B) contains at least 19.9% of B-10 isotope.

9. The method according to claim 3, wherein the gadolinium (Gd) contains at least 15.65% of Gd-157 isotope.

10. The method according to claim 1, wherein average particle diameter of the neutron absorption material is below 5 μm.

11. The method according to claim 1, wherein average particle diameter of the neutron absorption material is between 10 nm˜1 μm.

12. The method according to claim 1, wherein the neutron absorption material is injected along with pH control agents into the spent nuclear storage water in which cooling function is lost.
